(19) United States
(12) Patent Application Publication
(10) Pub. No.: US 2008/0288127 A1
(43) Pub. Date: Nov. 20, 2008

(54) Data Processing Device and Method for the Operation Thereof

(76) Inventor: Horst Nather, Villingen-Schwenningen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/092,384

(22) PCT Filed: Oct. 6, 2006
(86) PCT No.: PCT/EP06/67146

§ 371 Date: May 1, 2008

(30) Foreign Application Priority Data
Nov. 7, 2005 (DE) 10 2005 052 971.2

(51) Int. Cl. G06F 19/00

(52) U.S. Cl. 701/1

(57) ABSTRACT

A data processing device (1), particularly a tachograph (DTCO) for a motor vehicle, has functional modules (FM) that control certain functions of the data processing device (1) or connected apparatuses, and data modules (DT) which trigger the functional modules in order to utilize the functions. The disadvantage in prior art lies in the fact that the adjustment effort is substantial because the entire product is adjusted. To decrease the effort required to make modifications while reducing the error proneness of said modifications, a communication module (ComCM) is supplied that cooperates with at least one standard interface module (CM) encompassing memory buffer address areas (SADR 1 to SADR 5), the communication module (ComCM) communicating at least one memory buffer address area (SADR 1) to a first data module (DT) so as to trigger a first functional module (FM).

### CROSS-REFERENCE TO RELATED APPLICATIONS

This application is a U.S. national stage application of International Application No. PCT/EP2006/067146 filed Oct. 6, 2006, which designates the United States of America, and claims priority to German application number 10 2005 052 971.2 filed Nov. 7, 2005, the contents of which are hereby incorporated by reference in their entirety.

### TECHNICAL FIELD

The invention relates to a data processing device, in particular a tachograph for a motor vehicle, having function modules which control specific functions of the data processing device or connected apparatuses, and having data modules which actuate the function modules in order to utilize the functions. In addition, the invention relates to a method for operating a data processing device, in particular of the above-mentioned type.

### BACKGROUND

Modern software with complex functionality is generally constructed according to a layer model, for example the Open Systems Interconnections Reference Model, in order to simplify the presentation of the complex contents by means of a hierarchical structure and to make the individual functions easier to understand. In the layer which is provided with the attribute “top”, modules are usually found for controlling and evaluating data, and in the layer which is designated as “bottom”, driver modules for various interfaces and functions or external devices such as, for example, printers or sensors, are frequently found. Since the individual layers must together form a unit which functions in a coordinated fashion, extensive communication between the layers is necessary. In this context, the customary communication modes between the programs of the individual layers are applied. The communication with the bottom layer or the drivers of the interfaces is particularly complex and susceptible to faults here since said communication requires a particular device-specific syntax in order, for example, to actuate external devices. Taking the example of a tachograph with which the invention is preferably used, a high degree of programming expenditure is found to occur in particular for the communication with the driver module of the rotational speed sensor since a large number of data modules can access the latter, these data modules being, for example, an event evaluation module, the actuation means for a display unit or a real time clock. In this context it is customary that the modules or programs which communicate with the bottom layer each have a communication syntax, as an integral component, which is coordinated with the corresponding driver. If, for example, an external device changes as a result of an adaptation of the product as a whole, the expenditure on adaptation in a plurality of layers of the layer model is considerable. This restricts the flexibility of the product greatly and gives rise to high costs for changes, which also frequently entail faults in the complex function. A tachograph in which the invention can preferably be used is described, for example, in European patent EP 1 493 129 B1.

### SUMMARY

According to an embodiment, the expenditure and the susceptibility of changes to a data processing device, in particular to a tachograph, to faults can be reduced. To this end, a data processing device such as a tachograph (DTCO) for a motor vehicle, may comprise function modules which control specific functions of the data processing device or connected apparatuses, data modules which actuate the function modules in order to utilize the functions, and a communication module which interacts with at least one standard interface module which comprises buffer address areas, wherein the communication module communicates at least one buffer address area to a first data module in order to actuate a first function module.

According to another embodiment, the communication module may communicate a buffer address area to the first function module. According to another embodiment, the function modules each may comprise at least one driver module by means of which the function modules are actuated. According to another embodiment, the buffer address area which is communicated to the data module and the buffer address area which is communicated to the function module may be identical. According to another embodiment, the buffer address area which is communicated to the data module and the buffer address area which is communicated to the function module can also be different. According to another embodiment, the driver module or the function module may have at least one buffer address area into which data which is to be transmitted to the driver module is input. According to another embodiment, the communication module may communicate to the data module buffer address areas of the standard interface module, specifically a first buffer address area for writing and a second buffer address area for reading, and the communication module communicates, to the function module, buffer address areas of the standard interface module, specifically a third buffer address area for writing and a fourth buffer address area for reading. According to another embodiment, in response to the request by a data module for access to a function module, the communication module may firstly interrogate the requested function module with respect to the availability for the requested access. According to another embodiment, the data modules can be assigned priorities with respect to the access to function modules, according to which priorities the requests by the function modules are processed under the control of the communication module. According to another embodiment, the standard interface module may transmit the data of the buffer address area of a data module for writing provided with a communication protocol into the buffer address area of a function module for reading. According to another embodiment, the communication module may control the interaction of data modules, standard interface module and function modules, in particular coordinates the start of reading out of data from a buffer address area with the end of the writing of data into a buffer address area.

According to a further embodiment, a method for operating a data processing device or a data processing device, may comprise the steps of providing a communication module which interacts with at least one standard interface module which comprises buffer address areas, in such a way that, in order to actuate a first function module, a first data module sends a request to the communication module, and the communication module communicates at least one buffer address area to the first data module.

According to another embodiment, the function modules may comprise driver modules by means of which the function modules are actuated. According to another embodiment, the communication module may communicate a buffer address area of the standard interface module to the first function module.

According to another embodiment, the buffer address area which is communicated to the data module for writing and the buffer address area which is communicated to the function module for reading can be identical or different. According to another embodiment, the communication module may communicate to the data module buffer address areas of the standard interface module, specifically a first buffer address area for writing and a second buffer address area for reading, and in that the communication module communicates, to the function module, buffer address areas of the standard interface module, specifically a third buffer address area for writing and a fourth buffer address area for reading. According to another embodiment, According to another embodiment, in response to the request by a data module, the communication module may firstly interrogate the requested function module with respect to the availability for the requested access. According to another embodiment, the data modules can be assigned priorities with respect to the access to function modules, according to which priorities the requests by the function modules are processed under the control of the communication module. According to another embodiment, the standard interface module may transmit the data of the buffer address area of the function module for writing provided with a communication protocol into the buffer address area of the function module for reading. According to another embodiment, the communication module may control the interaction of data modules, standard interface module and function modules, in particular coordinates the start of reading out of data from a buffer address area with the end of the writing of data into a buffer address area. According to another embodiment, in a first step the data module requests a first buffer address area of the standard interface module for a function module from the communication module, in a second step the communication module requests a fifth buffer address area of the standard interface module for the function module from the function module or the driver module, in a third step the communication module transfers the fifth buffer address area to the standard interface module, in a fourth step the standard interface module communicates a first buffer address area for the data module to the communication module, in a fifth step the communication module transfers the first buffer address area of the standard interface module to the data module, in a sixth step the data module writes data into the first buffer address area of the standard interface module, in a seventh step the standard interface module provides the data from the first buffer address area with a communication protocol, and in an eighth step copies the data into a buffer address area of the driver module.

Any embodiment may extend also to embodiments provided on the basis of any applicable combination of the above mentioned features.

### BRIEF DESCRIPTION OF THE DRAWINGS

In the text which follows the invention will be described in more detail using an exemplary embodiment and with reference to drawings in order to clarify the invention without restricting it to specific forms of the exemplary embodiment. In said drawings:

FIG. 1 is a schematic illustration of the assignment of data modules and function modules and of the interaction with the communication module according to an embodiment and the standard interface module, and

FIG. 2 shows the basic sequence of the interaction of the communication module, the standard interface module, a data module and a function module or driver module.

### DETAILED DESCRIPTION

Function modules according to various embodiments are to be understood in particular as the driver modules and the components or devices and their controllers which interact therewith, for example asynchronous drivers, synchronous drivers, drivers for a carrier network, drivers for a rev counter or for measurement of a velocity-related signal of a utility vehicle, drivers for a display unit or a printer and similar modules. Data modules according to various embodiments which are located in an upper layer are, for example, modules for handling data carriers or for downloading or for calibrating or for evaluating movements or events or modules for actuating display units or printers or a real time clock.

A decisive advantage of a data processing device according to various embodiments or a method according to various embodiments is the provision of a central module, the communication module, which forms the connection between data modules and function modules by means of the standardized interface or the standard interface module, and also coordinates and manages the access to multiply used drivers. This embodiment avoids expenditure on the adaptation of individual communication solutions of data modules to function modules which is costly and susceptible to faults, and in this way makes the system not only easier to understand but also allows it to be tested better. Changes to fundamental concepts can also be carried out more easily in this way.

A useful application of the various embodiments occurs if the function modules each comprise at least one driver module by means of which the function modules, for example external devices, are actuated. In this way it is possible, if appropriate, also for driver modules which are supplied with the function modules from different manufacturers to be used with little effort.

A solution which is particularly economical in terms of memory space is obtained if the buffer address area which is communicated to the data module for writing and the buffer address area which is communicated to the function module for reading are identical. This solution is suitable in particular if the data which is to be transmitted from the data module to the function module is to be passed on in an essentially unchanged form. If, on the other hand, comprehensive changes are necessary to the data, it is expedient if the two buffer address areas are different. This may be the case, for example, when a communication protocol is being provided.

The communication is advantageously also assisted by the communication module according to various embodiments if the driver module or the function module has at least one buffer address area into which data which is to be transferred to the driver module is input.

The communication module and also the function modules or driver modules expediently each have buffer address areas for output data and input data and for status information and adjustment parameters. These addresses have to be exchanged with one another at the start of an access operation. According to various embodiments, the communication module is responsible for this exchange, said communication module carrying out or controlling and coordinating this exchange in an initialization phase of the communication.

Comprehensive flexibility is obtained if the communication module communicates to the data module buffer address areas of the interface module, preferably a first buffer address area for writing and a second buffer address area for reading. In addition, it may be useful if the communication module communicates, to the function module, buffer address areas of the interface module, specifically a third buffer address area for writing and a fourth buffer address area for reading.

In order to manage the access to multiply used function modules or their driver modules it is useful if, in addition, in response to the request by a data module for access to a function module, the communication module firstly interrogates the requested function module with respect to the availability for the requested access.

In order to clarify access conflicts in a functionally appropriate way, it is useful if the data modules are assigned priorities with respect to the access to function modules, according to which priorities the requests by the function modules are processed under the control of the communication module. If a function module is, for example, occupied and if the communication channel or the requesting data module has a higher priority than the one which is occupying the function module, a “release call” can be sent to the data module or the channel which is using the function module, in response to which the data module which is using the function module terminates the communication and releases the function module or the corresponding driver module. If immediate access is necessary, the standard interface module can switch over the communication immediately. This can be communicated by means of an “abort message” to the data module whose communication has been aborted. According to various embodiments it is useful if the communication module controls the interaction of data modules, standard interface module and function modules, in particular coordinates the start of reading out of data from a buffer address area with the end of the writing of data into a buffer address area, in particular into the buffer address area which is to be read out.

A particularly expedient development of the method according to various embodiments is described in steps in the text which follows. In a first step the data module requests a first buffer address area of the standard interface module for a function module from the communication module. Then, in a second step the communication module requests a fifth buffer address area of the standard interface module for the function module from the function module or the driver module. In a third step the communication module transfers the fifth buffer address area to the standard interface module. In a fourth step the first buffer address area is communicated to the communication module by the standard interface module. Subsequently, in a fifth step the communication module transfers the first buffer address area of the standard interface module to the data module. After this coordination of the communication by the communication module, in a sixth step the data module writes data into the first buffer address area of the standard interface module. In a seventh step, this data is provided with a communication protocol by the standard interface module so that in an eighth step the data can be copied into a buffer address area of the driver module. The driver module transfers the correspondingly adapted data to the requested function, for example a printout based on this data is made.

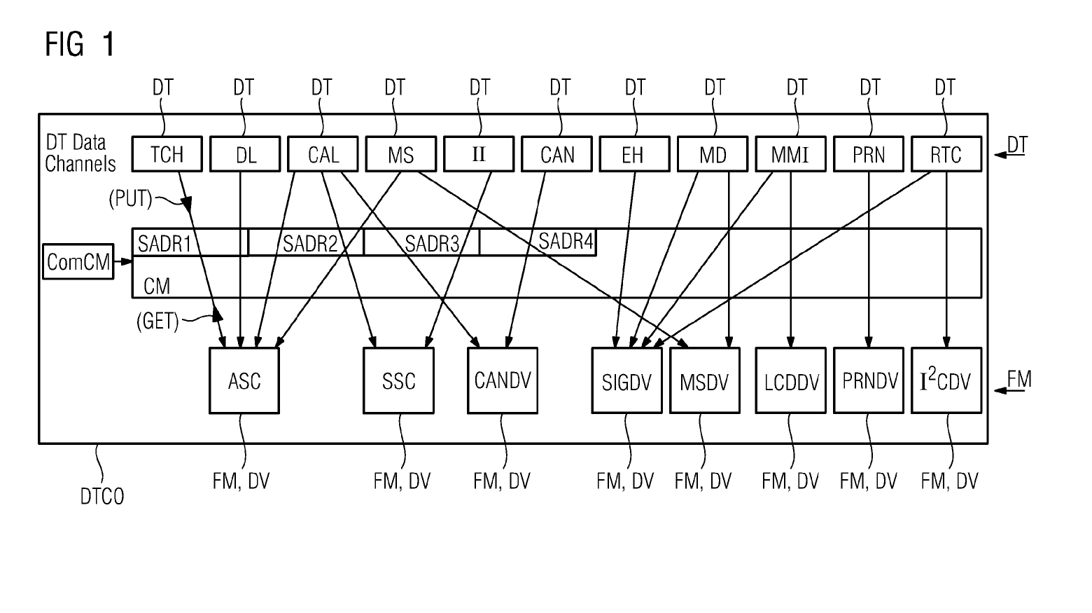

FIG. 1 illustrates the interaction of a communication module ComCM, a standard interface module CM for a plurality of data modules DT and a plurality of function modules FM or driver modules DV. During the communication with the function modules FM, the data modules DT use the services provided by the communication module ComCM in such a way that the communication module ComCM configures a standard interface module CM and makes available or communicates corresponding buffer address areas SADR1 to SADR5 to the subscribers to the communication. The communication module ComCM coordinates and controls the communication between the data modules DT and the function modules FM and the driver modules DV which are associated with the function modules FM, in particular through the provision of buffer address areas, here in particular for output data (Put), input data (Get), status information and setting parameters. In an initialization phase before each communication, the communication module ComCM communicates basic settings to the subscribers.

The data modules are, in particular, a data card module TCH which regulates the handling of an inserted data card,

a download module DL which control download processes,
a calibration module CAL which controls the calibration of measurement processes,
a measurement module MS which controls a measurement by means of a movement sensor,
an information module II which actuates an information interface,
a network module CANM which regulates the exchange of signals with a Car Area Network CAN,
an evaluation module EH which performs the evaluation of events,
a movement module MD which evaluates movement data,
a display module MMI which actuates a display unit, a printing module PRN which performs the actuation of a printer, and
a real time clock RTC.

The function modules or the associated driver modules comprise, in particular, asynchronous drivers ASC, synchronous drivers SSC, drivers for the Car Area Network CAN, drivers for a rotational speed transmitter SIGDV, a driver for a movement signal MSDV, a driver for a display unit LCDDV, a driver for a printer PRNDV and a driver for a bus system I2CDV. The arrows in the schematic illustration of the tachograph DTCO which lead from the data modules DT to the function modules FM or driver modules DV respectively symbolize a communication which may not only occur unidirectionally but also bidirectionally.

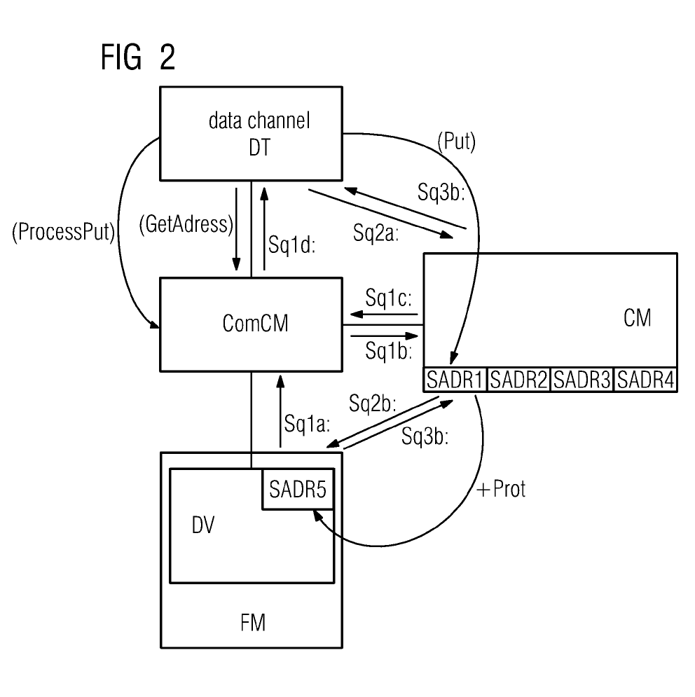

FIG. 2 shows a simplified schematic illustration of the interaction of an individual data module DT in the communication with a driver module DV or function module FM assisted by the communication module ComCM and the standard interface module CM. As a result, references to processes are placed between parentheses ( . . . ) in the illustration.

In the illustrated interaction, the data module DT requests a first buffer address area SADR1 of the standard interface module CM for the function module FM or the driver module DV (GetAdress) from the communication module ComCM. Subsequently, the communication module ComCM requests a fifth buffer address area SADR5 from the driver module DV (Sq1a). The transferred fifth buffer address area SADR5 is passed on from the communication module ComCM to the standard interface module CM (Sq1b), after which the standard interface module CM passes back the first buffer address area SADR1 for the data module DT to the communication module ComCM (Sq1c). In a subsequent step (Sq1d), the communication module ComCM transfers the first buffer address area SADR1 of the standard interface module CM to the data module DT.

On the basis of the exchanged buffer address areas SADR1, SADR5, the data module DT stores data in the first buffer address area SADR1 (Put) and makes the communication module ComCM call the standard interface module CM (ProcessPut, Sq2a). The called standard interface module CM adds a communication protocol PROT to the data and copies the supplemented data into the fifth buffer address area SADR5. At the same time, the communication module ComCM interrogates the status of these processes (PutFin).

If the communication module ComCM identifies the end of the processes, it calls the driver module DV so that the latter sends this data (Sq2b) for further use, for example by a printer (in the case of PRNDV).

The data module DT then requests the reading of received data from the communication module ComCM, which passes on this request to the driver module DT, after which the driver module DT copies the requested data into a fourth buffer address area SADR4 of the standard interface module CM (Sq3a). After the transmission of data from the driver module DV to the standard interface module CM or the fourth buffer address area SADR4 has ended, the communication module ComCM transmits to the standard interface module CM the instruction to remove the communication protocol PROT from the transferred data. After this conditioning of the data has been concluded, the communication module ComCM which monitors the status of the communication processes transmits to the data module DT the message that the requested data can be read out from the second buffer address area SADR2.

1. A data processing device or tachograph (DTCO) for a motor vehicle, comprising: function modules which control specific functions of the data processing device or connected apparatuses,
data modules which actuate the function modules in order to utilize the functions, and
a communication module which interacts with at least one standard interface module which comprises buffer address areas, wherein the communication module communicates at least one buffer address area to a first data module in order to actuate a first function module.

2. The data processing device according to claim 1, wherein the communication module communicates a buffer address area to the first function module.

3. The data processing device according to claim 1, wherein the function modules each comprise at least one driver module by means of which the function modules are actuated.

4. The data processing device according to claim 1, wherein the buffer address area which is communicated to the data module and the buffer address area which is communicated to the function module are identical.

5. The data processing device according to claim 1, wherein the buffer address area which is communicated to the data module and the buffer address area which is communicated to the function module are different.

6. The data processing device according to claim 1, wherein the driver module or the function module has at least one buffer address area into which data which is to be transmitted to the driver module is input.

7. The data processing device according to claim 1, wherein the communication module communicates to the data module buffer address areas of the standard interface module, specifically a first buffer address area for writing and a second buffer address area for reading, and the communication module communicates, to the function module, buffer address areas of the standard interface module, specifically a third buffer address area for writing and a fourth buffer address area for reading.

8. The data processing device according to claim 1, wherein, in response to the request by a data module for access to a function module, the communication module firstly interrogates the requested function module with respect to the availability for the requested access.

9. The data processing device according to claim 1, wherein the data modules are assigned priorities with respect to the access to function modules, according to which priorities the requests by the function modules are processed under the control of the communication module.

10. The data processing device according to claim 1, wherein the standard interface module transmits the data of the buffer address area of a data module for writing provided with a communication protocol into the buffer address area of a function module for reading.

11. The data processing device according to claim 1, wherein the communication module controls the interaction of data modules, standard interface module and function modules, in particular coordinates the start of reading out of data from a buffer address area with the end of the writing of data into a buffer address area.

12. A method for operating a data processing device or data processing device, comprising the steps of:
providing a communication module which interacts with at least one standard interface module which comprises buffer address areas, in such a way that, in order to actuate a first function module, a first data module sends a request to the communication module, and the communication module communicates at least one buffer address area to the first data module.

13. The method according to claim 12, wherein the function modules comprise driver modules by means of which the function modules are actuated.

14. The method according to claim 12, wherein the communication module communicates a buffer address area of the standard interface module to the first function module.

15. The method according to claim 12, wherein the buffer address area which is communicated to the data module for writing and the buffer address area which is communicated to the function module for reading are identical.

16. The method according to claim 12, wherein the buffer address area which is communicated to the data module for writing and the buffer address area which is communicated to the function module for reading are different.

17. The method according to claim 12, wherein the communication module communicates to the data module buffer address areas of the standard interface module, specifically a first buffer address area for writing and a second buffer address area for reading, and in that the communication module communicates, to the function module, buffer address areas of the standard interface module, specifically a third buffer address area for writing and a fourth buffer address area for reading.

18. The method according to claim 12, wherein, in response to the request by a data module, the communication module firstly interrogates the requested function module with respect to the availability for the requested access.

19. The method according to claim 12, wherein the data modules are assigned priorities with respect to the access to function modules, according to which priorities the requests by the function modules are processed under the control of the communication module.

20. The method according to claim 12, wherein the standard interface module transmits the data of the buffer address area of the function module for writing provided with a communication protocol into the buffer address area of the function module for reading.

21. The method according to claim 12, wherein the communication module controls the interaction of data modules, standard interface module and function modules, in particular coordinates the start of reading out of data from a buffer address area with the end of the writing of data into a buffer address area.

22. The method according to claim 12, wherein in a first step the data module requests a first buffer address area of the standard interface module for a function module from the communication module, in a second step the communication module requests a fifth buffer address area of the standard interface module for the function module from the function module or the driver module,
in a third step the communication module transfers the fifth buffer address area to the standard interface module,
in a fourth step the standard interface module communicates a first buffer address area for the data module to the communication module,
in a fifth step the communication module transfers the first buffer address area of the standard interface module to the data module,
in a sixth step the data module writes data into the first buffer address area of the standard interface module,
in a seventh step the standard interface module provides the data from the first buffer address area with a communication protocol, and
in an eighth step copies the data into a buffer address area of the driver module.
